(19) United States
(12) Patent Application Publication
(10) Pub. No.: US 2004/0253931 A1
(43) Pub. Date: Dec. 16, 2004

(54) Rotator with rim select functionality

(76) Inventors: Jakob Bonnelykke, Valmuevej (DK); Rasmus Christjansen, Hedetoften (DK)

Correspondence Address: PERMAN & GREEN, LLP, 425 Post Road, Fairfield, CT, 06824, US

(21) Appl. No.: 10/458,401

(22) Filed: Jun. 10, 2003

(51) Int. Cl. H04Q 7/20

(52) U.S. Cl. 455/90.3

(57) ABSTRACT

This invention relates to a rotator translating angular movement into an output representation. In particular, this invention relates to a rotator input device for detecting user interaction. The rotator input device comprises a rotator element arranged on a support enabling angular and tilting movement of the rotator element relative to rotational axis of the rotator element and having an operating surface perpendicular to the axis. The rotator input device further comprises a motion detector for detecting angular movement of the rotator element, a switching assembly for detecting tilting movement of the rotator element during depression of the operating surface and comprises a first plurality switching elements arranged below the operating surface and substantially along the periphery of the rotator element.

### FIELD OF INVENTION

This invention relates to a rotator translating angular movement into an output representation. In particular, this invention relates to a rotator for a mobile communication device enabling a user of the mobile communication device to navigate in a user interface by turning the rotator.

### BACKGROUND OF INVENTION

A mobile communication device, such as a mobile communication device, a satellite telephone, or a cell or mobile telephone, generally comprises a display and a keyboard for interfacing the user to the mobile communication device.

The size of the mobile communication device is primarily limited by the size of the display and keyboard. It is desirable for the mobile communication device to be compact so that the user may place the mobile communication device in a pocket. While both the display and the keyboard may be reduced in size, the display must be large enough so that characters displayed on it are large enough to be read by the user. The keyboard must be large enough so that the user is able to input data without inadvertently activating two keys at the same time.

It is a desirable feature of a mobile communication device that the display is large enough to recognise the data which has been input by the user with the keyboard and to allow the user to use other applications on the mobile communication device, the playing of games being one such application. It is therefore undesirable that the display size be reduced. The dimensions of a mobile communication device are limited by the display and keyboard unless an alternative form of user input to replace the keyboard is made available.

The mobile telephone, Nokia 7110, as described in EP 0901262, includes a roller key for navigating a cursor on a display. The rotational movement of the roller key is detected using a mechanical conductive switch which added to the dimension requirements of the device. Hence the roller key provides a functional and easy method of interfacing a user and the mobile telephone, however, the roller key rotates around a rotation axis, which is perpendicular to the depression direction.

Further, U.S. Pat. No. 6,192,258 describes a mobile communication device having a rotary push switch enabling a user to scroll through anchor points (personal data), to focus on an anchor point, and to activate automatic dialling to the focussed anchor point by pushing the rotary push switch. The pushing action of the rotary push switch is performed in a direction perpendicular to the axis of the rotary push switch, thus requiring complicated mechanical considerations during in the design.

Furthermore, U.S. Pat. No. 6,396,006 describes a push and rotary operating type electronic device comprising a discoidal operating knob, which may be moved axially so as to allow both rotary manipulation and depressing manipulation of the device. The structure allows the operating knob to tilt easily up to a certain angle so as allow for a smooth rotational operation. Nevertheless, the user is required to perform an axial movement of the operating knob in order to achieve a switching action.

In addition, International patent application WO 03/005336 describes a mobile telephone having a keypad, which is depressible along a plurality of directions and can be switched between a first and second mode, wherein each combination of depressible direction and mode represent a unique group of alphanumeric letters. Numeral keys may be arranged in an annulus, which may be rotated and keyed with the keypad.

The European patent application no. EP 0901262, the American patents nos. U.S. Pat. No. 6,192,258 and U.S. Pat. No. 6,396,006, and the International patent application no. WO 03/005336, mentioned above are hereby incorporated in the present specification by reference.

One of the problems of the prior art technology is the constant requirement of miniaturisation of mobile telephone technology. That is, how to make and operate a mobile telephone, which has a convenient transportable size while still providing an usable interface between mobile telephone and user.

### SUMMARY OF THE INVENTION

An object of the present invention is therefore to solve the above problem, by presenting a mobile communication device providing a multifunctional rotator input unit.

A particular advantage of the present invention is the provision of an interface, which firstly is compact, secondly is easy to operate, and thirdly establishes an interface with a reduced number of individual switches.

A particular feature of the present invention is the provision of a depressible rim section of a rotator enabling a user multiple selections.

The above objects, advantage and feature together with numerous other objects, advantages and features, which will become evident from below detailed description, is obtained according to a first aspect of the present invention by a rotator input device for detecting user interaction and comprising a support, a rotator element arranged on the support enabling angular and tilting movement of the rotator element relative to rotational axis of the rotator element and having an operating surface perpendicular to the axis, a motion detector for detecting angular movement of the rotator element, a switching assembly for detecting tilting movement of the rotator element during depression of the operating surface and comprising a first plurality switching elements arranged below the operating surface and substantially along the periphery of the rotator element.

A particular advantage of the rotator input device according to the first aspect of the present invention is the fact that the rotator enables a user to depress the operating surface along the periphery of the rotator element and thereby achieve a plurality of actions, e.g. by depressing the operating surface on one side of the rotator element might be interpreted as a left manoeuvring action and by depressing the operating surface on the opposite side of the rotator element might be interpreted as a right manoeuvring action. Hence the rotator input device according to the first aspect of the present invention is useful in a wide variety of electrical appliances, where the size of the user interface is of particular importance.

The rotator element according to the first aspect of the present invention may comprise an axially open section around the rotation axis and a rim section extending from the periphery of the rotator element to the open section, wherein the operating surface substantially may cover the rim section. The rotator element may be formed in any shape such as a disc or a wheel having a circumference such as circular, oval, triangular, square or any combination thereof.

The rotator input device according to the first aspect of the present invention may further comprise a navigation key having a depression surface. Further, the navigation key may be arranged on the support so that the depression surface is accessible through the open section of the rotator element. The depression surface defines a plane which may be parallel to the operating surface of the rotator element.

The navigation key provides a further advantage of the present invention since it greatly improves the applicability of the user interface. The navigation key may be used in combination with the rotator element so as to provide a push action utility of the rotary input device.

The switching assembly may comprise a second switching element arranged below the depression surface of the navigation key for detecting depression of the depression surface. The second switching element may comprises a plurality of plurality of individual switching elements connected so as to provide detection of depression of the depression surface even in cases where the depression of the navigation key is slightly tilted relative to the rotation axis of the rotator element.

Each of the switching elements according to the first aspect of the present invention may comprise a first and second contact surface separated by a dome shaped space and may generate a first electric contact signal when the space is changed during depression. Alternatively, the switching elements may comprise surface mounted device (SMD) switches. The switching elements may activate in accordance with changes in resistance, capacitance, inductance or any combination thereof. The switching elements may be implemented on a dome sheet or a printed circuit board (PCB).

The first plurality of switching elements according to a first aspect of the present invention may be separated with an even angular space there between around the circumference of the rotator element. The angular space may for example be 90°, but may as a matter of fact be implemented as 360° divided by any integer e.g. an angular space of 11.25°, 22.5°, or 45°. When the angular space is 90°, then 4 switching elements are required to evenly cover the rim section of the rotator element. Hence, the first plurality of switching elements may comprise any number of elements in the range from 2 to 1024 such as 2, 4, 8, 16, 32, 64, 128 or 256 switching elements.

The above objects, advantages and features together with numerous other objects, advantages and features, which will become evident from below detailed description, is obtained according to a second aspect of the present invention by a mobile communication device comprising a processor, a display for presenting data for a user, and a rotator input device for detecting user interaction, wherein said rotator input device comprising a support, a rotator element arranged on said support enabling angular and tilting movement of said rotator element relative to the rotational axis of said rotator element and having an operating surface perpendicular to said axis, a motion detector for detecting angular movement of said rotator element, a switching assembly for detecting tilting movement of said rotator element during depression of said operating surface and comprising a first plurality switching elements arranged below said operating surface and substantially along the periphery of said rotator element.

A particular advantage of the mobile communication device according to the second aspect of the present invention is the provision of a rotator input device, since the rotator input device compliments the objects of the present invention since the problems of miniaturisation is solved, while maintaining a user interface which is readable and therefore workable. The rotator element may be supported by a further keypad so as to allow for a plurality of short cut actions to be taken without having to toggle through any menus display on the display.

The mobile communication device according to the second aspect of the present invention may be constituted by a mobile or cellular phone, a radio or satellite telephone, a computer, a personal digital assistant, a camera, or any combination thereof. In fact, the communication device may be a digital or analogue television or video monitor, a set-top box, a remote control device, or any combination thereof.

The processor according to the second aspect of the present invention may be operable to present data on said display, to receive user interaction data from said motion detector and said switching assembly, and to correlate said user interaction data with data presented on said display and thereby enabling a user to interface with said data presented on said display. The processor may handle the data correlation so as to ensure the interface between the mobile communication device and the user operates according to an efficient and effective manner. The data presented on the display may be menus presenting options for a user to select, or may be games enabling a user to manoeuvre through a series of pictures by utilising the rotator input device.

The processor according to the second aspect of the present invention may converts user interaction data from said motion detector to a data toggling action, and user interaction data from said switching assembly to a data selection action. However, as described above the processor may utilise the user interaction data to present the user with manoeuvrability in a game.

The use of the rotator input device in a mobile communication device allows the user to select menu choices displayed on the display and to input data by scrolling through an alphanumeric list. The use of the, for example, three or more reflective surfaces in a repetitive sequence also enables the orientation of rotation to be determined allowing the user to select menu choices by either scrolling up or down a menu list. The use of three or more reflective surfaces allows the use of a single transmitter and receiver module for determining the direction of rotation. The use of a rotator input device with the electromagnetic transmitter/receiver set-up also allows the user input means to be low profile and extremely suitable for implementation within a mobile communication device.

The above objects, advantages and features together with numerous other objects, advantages and features, which will become evident from below detailed description, is obtained according to a third aspect of the present invention by a method for registering user interaction on a mobile communication device comprising

(a) presenting visual data on a display,

(b) enabling angular and tilting movement of a rotator element relative to rotational axis of said rotator element having an operating surface perpendicular to said axis,

(c) detecting angular movement of said rotator element and generating angular movement data, and

(d) detecting tilting movement of said rotator element during depression of said operating surface and generating tilting movement data.

The method according to the third aspect of the present invention may further comprise (e) correlating said visual data, said angular movement data, and said tilting movement data and generating an processing action.

A particular advantage of the method according to the third aspect of the present invention is the provision of a fast and simple user interface, which as described above with reference to the first and second aspect of the present invention, accomplishes two important objects, namely miniaturisation and good interface. By incorporating a tilting detection functionality in a mobile communication device, a significantly improved interface is achieved since the display determines the visibility of the visual data and not the size of the operating knobs on any particular keypad.

The method according to the third aspect of the present invention may further comprise presenting a selection prompt on the display. Further, generating a processing action may comprise moving the selection prompt presented on the display in accordance with angular and tilting movement data so that the selection prompt presents the user of the mobile communication device with further processing actions. That is, the prompt enables the user to instantly see how the movement of the rotor element changes the possibilities of the actions which may be taken.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1, shows in perspective a mobile communication device according to a first embodiment of the present invention;

FIG. 2, shows in perspective a mobile communication device according to a second embodiment of the present invention;

FIG. 3, shows in perspective a rotator input device according to a second embodiment of the present invention;

FIG. 4, shows an exploded view of the rotator input device according to the second embodiment of the present invention; and

FIG. 5, shows a cross-sectional view of rotator input device according to a third embodiment of the present invention.

### DETAILED DESCRIPTION OF PREFERRED EMBODIMENTS

In the following description of the various embodiments, reference is made to the accompanying drawing comprising several figures which form a part hereof, and in which is shown by way of illustration various embodiments in which the invention may be practiced. It is to be understood that other embodiments may be utilized and structural and functional modifications may be made without departing from the scope of the present invention.

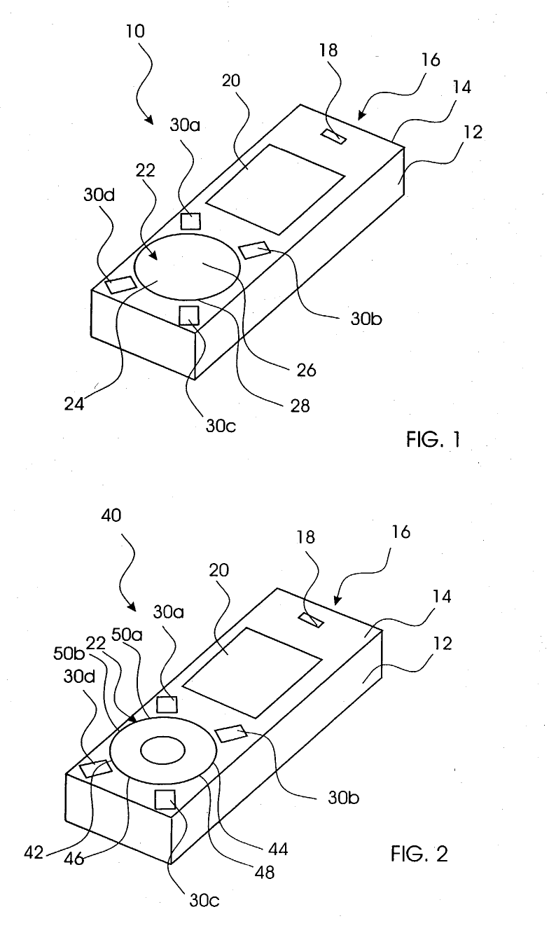

FIG. 1 shows a mobile communication device according to a first embodiment of the present invention and designated in entirety by reference numeral 10. The mobile communication device 10 comprises a housing 12 for containing processing, storing and communicating elements, not shown. The front side 14 of the housing 12 comprises a user interface 16 enabling a user to interact with the processing, storing and communicating elements of the mobile communication device 10.

The user interface 16 comprises a load speaker 18 for communicating audio data to the user of the mobile communication device 10, a display 20 for communicating visual data to the user, and a rotator input device 22 for enabling a user to input data to the processing element of the mobile communication device 10. The user utilises a disc shaped operating surface 24 of the rotator input device to rotate a rotator element supporting the operating surface 24 for manoeuvring through visual data presented on the display 20, and utilises the operating surface 24 to select visual data presented on the display 20 by depressing the operating surface 24. The operating surface may be depressed in a centre section 26 or a rim section 28 of the operating surface. Depression of the centre section 26 provides a first set of processing actions and depression of the rim section 28 provides a second set of processing actions. Further, the rim section 28 may be depressed at any point around the circumference of the operating surface 22 providing a plurality of sets of processing actions in accordance with circumferential depression position.

This functionality significantly improves the user interface, since a alphanumeric keypad is rendered unnecessary the size of the mobile communication device 10 may be reduced. Nevertheless, the mobile communication device may comprise further selection keypads 30a, b, c, and d for enabling a user to short cut directly to particular processing actions of the mobile communication device 10.

FIG. 2 shows a mobile communication device according to a second and preferred embodiment of the present invention and designated in entirety by reference numeral 40. The mobile communication device 40 comprises all elements described with reference to FIG. 1, which elements have been identically numbered in FIG. 2.

The user interface 16 of the mobile communication device 40 comprises a load speaker 18, a display 20, and a rotator input device 22 having a ring shaped operating surface 42. In addition, the user interface 16 comprises a navigation key 44 arranged in the centre of the ring shaped operating surface 42 and enabling a user of the mobile communication device 40 to select the first set of processing actions by depressing a depression surface 46 arranged on the navigation key 44.

The navigation key 44 in the preferred embodiment of the present invention enables the user to select a series of sets of processing actions by depressing along the rim 48. For example, depression at rim part 50a provides a first processing action while depression at rim part 50b provides a second processing action.

The ring shaped operating surface 42 enables the user to manoeuvre through visual data presented on the display 20 by rotating a rotator element supporting the ring shaped operating surface 42. In addition, as described above with reference to FIG. 2 the ring shaped operating surface 42 enables the user to select visual data presented on the display 20 by depressing the ring shaped operating surface 42. The ring shaped operating surface 42 along the circumference so as to provide a plurality of sets of processing actions in accordance with circumferential depression position.

As described above with reference to FIG. 1, the mobile communication device 40 according to the second embodiment may further comprise a plurality of keypads 30a, b, c, and d, to for example enable a user to short cut to a particular processing action.

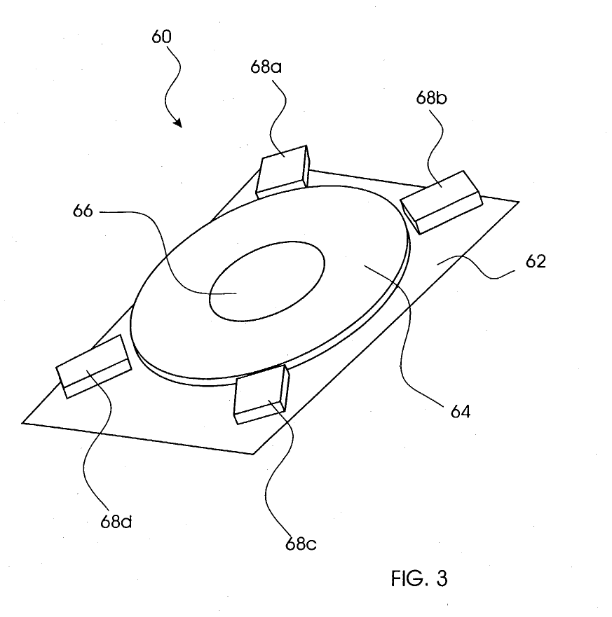

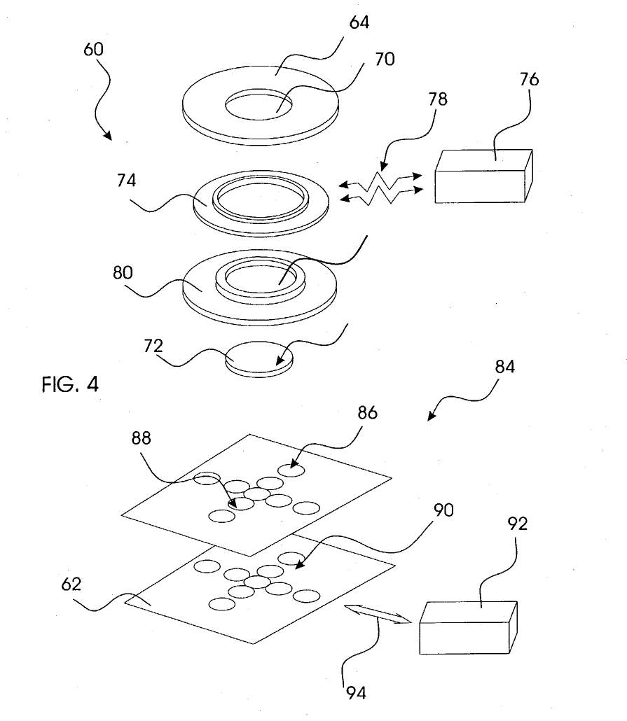

FIG. 3, shows a rotator input device according to the second and preferred embodiment of the present invention and designated in entirety by reference numeral 60. The rotator input device 60 comprises a support 62 for supporting a rotatable and depressible rotator element 64. Further, the rotator input device 60 comprises a navigation key 66 supported by the support 62. In addition, the rotator input device 60 may comprise a plurality of keypads 68a, b, c, and d.

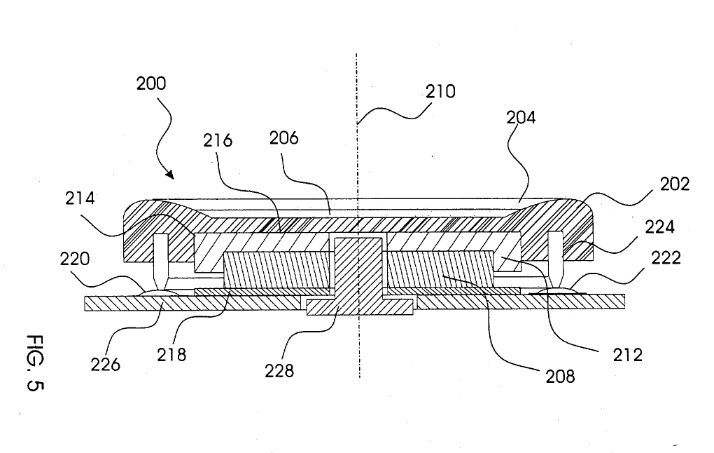

FIG. 4 shows an exploded view of the rotator input device 60 comprising the rotator element 64 having a central opening 70 so as to allow for the depression surface 72 of the navigation key 66 to be accessed through said opening 70. The rotator element 64 is arranged on a motion detector element 74 communicating with converter 76 through communicating means 78. The motion detector element 74 may be configured to utilise electromagnetic, acoustic, mechanical or optical coupling to determine angular motion of the rotator element 64.

When the motion detector element 74 utilises electro-magnetic, acoustic or optical coupling a transmitter for transmitting an incident signal on to the motion detector element 74 and a receiver for receiving the reflected incident signal from the motion detector element 74 are incorporated into the converter 76.

When the motion detector element 74 utilises mechanical coupling the communicating means 78 are constituted by a mechanical lever coupling to an indented area of the angular motion detector so that angular motion of the rotator element causes the lever to vibrate.

The motion detector element 74 is supported by a bearing element 80 enabling rotation of the interlocked ring shaped rotator element 64 and motion detector element 74. The bearing element 80 comprises a hole 82 for receiving the navigation key 66. Note the navigation key 66 is not supported by the bearing element 80 and thus is not rotatable.

The rotator input device 60 further comprises a switching assembly designated in entirety by reference numeral 84. The switching assembly 84 comprises a first sheet incorporating a first set of domes or switching elements 86 for communicating with the rotator element and a second set of domes or switching element 88 for communicating with the navigation key 66. The domes 86 and 88 comprise an upper and a lower surface layer separated by a space, which during alteration detectably changes electrical characteristics.

The change in electrically characteristics is identified by corresponding detectors 90 on the support 62. The changes detected by the detectors 90 are communicated to a translator 92 through communication means 94. The communication means 94 and the translator 92 may be established and integrated directly on the support 62. The support 62 may be a printed circuit board (PCB).

With reference to FIG. 4, the rotator element according to the first embodiment of the present invention may also be moved in a longitudinal direction e.g. depressed so as to activate a menu function once the menu choice has been highlighted by means of rotating the rotary dial. A user applying a force to the rotary dial may cause the dial to be depressed 130 activating a suitable sensor 131, which may correspond to the activation or selection of a menu option on the display 20.

FIG. 5 shows a cross-sectional view of a rotator input device according to a third embodiment of the present invention and designated in its entirety by reference numeral 200. The rotator input device 200 comprises a rotator element 202 having a operating surface 204 and a depression surface 206. The rotator element 202 is oppositely to the operating and depression surfaces 204 and 206 by a bearing element 208 enabling angular movement of the rotator element 202 about a rotation axis 210.

A motion detector element 212 is inserted in milled out section 214 of the rotator element 202 between the lower surface 216 of the rotator element 202 and the bearing element 208. Angular movement of the rotator element 202 is detected by a motion detector integrated onto a silicon wafer 218 and cooperating with the motion detector element 212.

The rotator input device 200 further comprises a plurality of dome switching element, partly shown in FIG. 5 as domes 220 and 222. The domes 220 and 222 may be activated by a reciprocated profile 224 extending from the lower surface 216 along the periphery of the rotator element 202. As the profile 224 alters the shape of the one of the domes an electric signal is generated and the contact may be registered.

The elements of the rotator input device 200 are supported by a support 226 such as a substrate or printed circuit board.

In addition to the profile 224 generating during depression of the operating surface, the depression surface 206 communicates with a stamp 228, which due to axial movement may generate a further electric signal so that the rotator input device 200 accomplishes registration of depression of the depression and operating surfaces as well as detecting angular movement of the rotator element 202.

What is claimed is:

1. Rotator input device for detecting user interaction and comprising a support, a rotator element arranged on said support enabling angular and tilting movement of said rotator element relative to the rotational axis of said rotator element and having an operating surface perpendicular to said axis, a motion detector for detecting angular movement of said rotator element, a switching assembly for detecting tilting movement of said rotator element during depression of said operating surface and comprising a first plurality switching elements arranged below said operating surface and substantially along the periphery of said rotator element.

2. Rotator input device according to claim 1, wherein said rotator element comprises an axially open section around said rotation axis and a rim section extending from the periphery of the rotator element to said open section.

3. Rotator input device according to claim 2, wherein said operating surface substantially covers said rim section.

4. Rotator input device according to claim 1, wherein each of said switching elements comprise a first and second contact surface separated by a dome shaped space and generates a first electric contact signal when said space is changed during depression.

5. Rotator input device according to claim 1, wherein said first plurality of switching elements are separated with an even angular space there between around the circumference of said rotator element.

6. Rotator input device according to claim 5, wherein said angular space is 90°.

7. Rotator input device for detecting user interaction and comprising a support, a rotator element arranged on said support enabling angular and tilting movement of said rotator element relative to the rotational axis of said rotator element and having an operating surface perpendicular to said axis, a motion detector for detecting angular movement of said rotator element, a switching assembly for detecting tilting movement of said rotator element during depression of said operating surface and comprising a first plurality switching elements arranged below said operating surface and substantially along the periphery of said rotator element, and wherein said rotator element comprises an axially open section around said rotation axis and a rim section extending from the periphery of the rotator element to said open section.

8. Rotator input device according to claim 7 further comprising a navigation key having a second depression surface, and said switching assembly comprising a second switching element arranged below said depression surface for detecting depression of said depression surface.

9. Rotator input device according to claim 8, wherein said navigation key is arranged on said support so that said depression surface is accessible through said open section of said rotator element.

10. Mobile communication device comprising a processor, a display for presenting data for a user, and a rotator input device for detecting user interaction, wherein said rotator input device comprising a support, a rotator element arranged on said support enabling angular and tilting movement of said rotator element relative to the rotational axis of said rotator element and having an operating surface perpendicular to said axis, a motion detector for detecting angular movement of said rotator element, a switching assembly for detecting tilting movement of said rotator element during depression of said operating surface and comprising a first plurality switching elements arranged below said operating surface and substantially along the periphery of said rotator element.

11. Mobile communication device according to claim 10, wherein said processor is operable to present data on said display, to receive user interaction data from said motion detector and said switching assembly, and to correlate said user interaction data with data presented on said display and thereby enabling a user to interface with said data presented on said display.

12. Mobile communication device according to claim 11, wherein said processor converts user interaction data from said motion detector to a data toggling action, and interaction data from said switching assembly to a data selection action.

13. Method for registering user interaction on a mobile communication device comprising:
(a) presenting visual data on a display,
(b) enabling angular and tilting movement of a rotator element relative to rotational axis of said rotator element having an operating surface perpendicular to said axis,
(c) detecting angular movement of said rotator element and generating angular movement data, and
(d) detecting tilting movement of said rotator element during depression of said operating surface and generating tilting movement data.

14. Method according to claim 13 further comprising (e) correlating said visual data, said angular movement data, and said tilting movement data and generating a processing action.

15. Method according to claim 13 further comprising presenting a selection prompt on said display.

16. Method according to claim 15, wherein said generating a processing action comprises moving said selection prompt presented on said display in accordance with angular and tilting movement data so that the selection prompt presents the user of the mobile communication device with further processing actions.
